(19) United States
(12) Patent Application Publication
(10) Pub. No.: US 2026/0030894 A1
(43) Pub. Date: Jan. 29, 2026

(54) INFORMATION PROCESSING APPARATUS, INFORMATION PROCESSING METHOD, AND INFORMATION PROCESSING SYSTEM

(71) Applicant: ISUZU MOTORS LIMITED, Yokohama-shi (JP)

(72) Inventor: Kazuto HONDO, Fujisawa-shi (JP)

(21) Appl. No.: 19/229,689

(22) Filed: Jun. 5, 2025

(30) Foreign Application Priority Data
Jul. 25, 2024 (JP) 2024-120186

(51) Int. Cl. G06V 20/54; G06V 10/62; G06V 10/74; G06V 10/77; G06V 20/58; G06V 40/20

(52) U.S. Cl. CPC G06V 20/54; G06V 10/62; G06V 10/761; G06V 10/7715; G06V 20/58; G06V 40/20; G06V 2201/08

(57) ABSTRACT

An information processing apparatus includes a determination unit that determines whether a target vehicle is a similar vehicle on the basis of the features of a registered vehicle and the features of the target vehicle indicated by feature information, and an output unit that outputs a route along which the similar vehicle has traveled on the basis of a plurality of positions at which a plurality of captured images including the similar vehicle were captured and a degree of confidence of the features of the similar vehicle.

### CROSS-REFERENCE TO RELATED APPLICATIONS

The present application claims priority to Japanese Patent Application No. 2024-120186, filed on Jul. 25, 2024, contents of which are incorporated herein by reference in their entirety.

### BACKGROUND OF THE INVENTION

The present disclosure relates to an information processing apparatus, an information processing method, and an information processing system.

A technique for tracking a stolen vehicle using a captured image obtained by an image capturing device mounted on a traveling vehicle has been proposed. For example, Patent Document 1 (Japanese Unexamined Patent Application Publication No. 2019-79330) describes tracking a stolen vehicle by having a server receive captured images of the stolen vehicle obtained at various positions by a plurality of vehicles and position information indicating positions corresponding to these captured images.

When the imaging environment of the image capturing device mounted on the vehicle is not favorable, it is not possible to accurately determine whether the vehicle that appears in the captured images is the stolen vehicle. Therefore, in the disclosure described in Japanese Unexamined Patent Application Publication No. 2019-79330, there is a problem in that a vehicle that is not a stolen vehicle may be erroneously recognized as the stolen vehicle.

### BRIEF SUMMARY OF THE INVENTION

The present disclosure has been made in view of this point, and its object is to provide an information processing apparatus, an information processing method, and an information processing system capable of suppressing erroneous recognition of a vehicle that is not a stolen vehicle as a stolen vehicle.

An information processing apparatus according to a first aspect of the present disclosure including: an acquisition unit that acquires, from a plurality of image capturing vehicles, (i) feature information indicating features of a target vehicle included in captured images obtained by capturing surroundings of each of the plurality of image capturing vehicles, (ii) confidence information indicating a degree of confidence in the feature information, and (iii) position information indicating positions at which the captured images were captured; a storage unit that stores features of a registered vehicle; a determination unit that determines whether the target vehicle is a similar vehicle on the basis of the features of the registered vehicle and the features of the target vehicle indicated by the feature information; and an output unit that outputs a route along which the similar vehicle has traveled on the basis of (i) a plurality of positions at which a plurality of captured images including the similar vehicle were captured and (ii) a degree of confidence of features of the similar vehicle.

An information processing method according to a second aspect of the present disclosure including the computer-implemented steps of: acquiring, from a plurality of image capturing vehicles, (i) feature information indicating features of a target vehicle included in captured images obtained by capturing surroundings of each of the plurality of image capturing vehicles, (ii) confidence information indicating a degree of confidence in the feature information, and (iii) position information indicating positions at which the captured images were captured; determining whether the target vehicle is a similar vehicle on the basis of the features of a registered vehicle and the features of the target vehicle indicated by the feature information by referencing a storage unit that stores the features of the registered vehicle; and outputting a route along which the similar vehicle has traveled on the basis of (i) a plurality of positions at which a plurality of captured images including the similar vehicle were captured and (ii) a degree of confidence of features of the similar vehicle.

An information processing system according to a third aspect of the present disclosure including a plurality of image capturing vehicles that capture surroundings; and an information processing apparatus that communicates with the plurality of image capturing vehicles, wherein any one of the image capturing vehicles includes: an image capturing device that generates captured images of the surroundings of the image capturing vehicle; an extraction unit that extracts features of a target vehicle included in the captured images; and a transmission control unit that transmits, to the information processing apparatus, (i) feature information indicating features of the target vehicle included in the captured images, (ii) confidence information indicating a degree of confidence in the feature information, and (iii) position information indicating positions at which the captured images were captured, and the information processing apparatus includes: an acquisition unit that acquires, from the plurality of image capturing vehicles, (i) feature information indicating features of a target vehicle included in captured images obtained by capturing surroundings of each image capturing vehicle, (ii) confidence information indicating a degree of confidence in the feature information, and (iii) position information indicating positions at which the captured images were captured; a storage unit that stores features of a registered vehicle; a determination unit that determines whether the target vehicle is a similar vehicle on the basis of the features of the registered vehicle and the features of the target vehicle indicated by the feature information; and an output unit that outputs a route along which the similar vehicle has traveled on the basis of (i) a plurality of positions at which a plurality of captured images including the similar vehicle were captured and (ii) a degree of confidence of features of the similar vehicle.

### BRIEF DESCRIPTION OF THE DRAWINGS

FIG. 1 illustrates a configuration of an information processing system S according to an embodiment.

FIG. 2 is a diagram illustrating a configuration of an image capturing vehicle.

FIG. 3 illustrates an example of feature information transmitted from a transmission control unit to an information processing apparatus.

FIG. 4 illustrates a configuration of the information processing apparatus.

FIG. 5 shows an example of a method of increasing estimation accuracy of a route.

FIG. 6 shows another example of estimation of a route by an estimation unit.

FIG. 7 is a flowchart showing a processing procedure of managing position information corresponding to feature information acquired by an acquisition unit.

FIG. 8 is a flowchart showing a processing procedure of estimating the route of the registered vehicle by the information processing apparatus.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

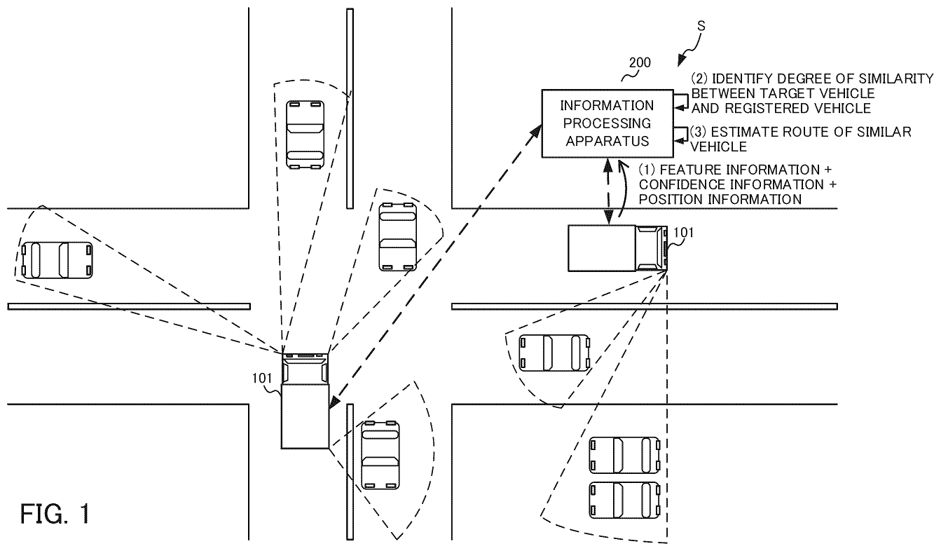

FIG. 1 shows a configuration of an information processing system S of the present embodiment. The information processing system S includes a plurality of image capturing vehicles 101 and an information processing apparatus 200. The image capturing vehicle 101 is a vehicle that captures its surroundings. The image capturing vehicle 101 transmits a captured image, which is generated by capturing the surroundings, to the information processing apparatus 200 via a network. The information processing apparatus 200 identifies a route along which a vehicle (hereinafter, referred to as a “similar vehicle”), which is a vehicle similar to a vehicle (for example, a stolen vehicle) registered in advance, travels by analyzing whether a similar vehicle that appears in the captured image received from the image capturing vehicle 101, and outputs the identified route.

Although two image capturing vehicles 101 are illustrated in FIG. 1, it is assumed that the information processing apparatus 200 receives captured images from three or more image capturing vehicles 101. The image capturing vehicle 101 is, for example, a commercial vehicle capable of autonomous driving. The image capturing vehicle 101 may be equipped with an ADAS (advanced driver assistance system) for supporting the driving operation of a driver.

While traveling, the image capturing vehicle 101 captures its surroundings using an image capturing device. The image capturing vehicle 101 recognizes a vehicle around the image capturing vehicle 101 (hereinafter, also referred to as a target vehicle) by performing image recognition on the captured image generated by the image capturing device. In FIG. 1, a plurality of target vehicles recognized by the image capturing vehicle 101 are each shown enclosed by a broken line.

The image capturing vehicle 101 extracts features such as a vehicle type and a vehicle registration number of the recognized target vehicle. The image capturing vehicle 101 identifies a degree of confidence representing the likelihood (reliability) of the extracted features. The image capturing vehicle 101 transmits (i) the extracted feature information indicating the features of the target vehicle, (ii) confidence information indicating the degree of confidence of the features represented by the feature information, and (iii) position information indicating a position of the image capturing vehicle 101 to the information processing apparatus 200 ((1) in FIG. 1).

The information processing apparatus 200 communicates with the plurality of image capturing vehicles 101. The information processing apparatus 200 acquires the feature information, the confidence information, and the position information from the image capturing vehicle 101. The information processing apparatus 200 stores the features of the registered vehicle. The registered vehicle is a vehicle whose features are registered in advance by a user in order to search for a position where the registered vehicle is located.

The information processing apparatus 200 identifies a degree of similarity between the stored features of the registered vehicle and the features of the target vehicle represented by the feature information acquired from the image capturing vehicle 101 ((2) in FIG. 1). The information processing apparatus 200 determines whether the identified degree of similarity is equal to or greater than a predetermined threshold value. The information processing apparatus 200 also acquires the feature information, the confidence information, and the position information from one or more other image capturing vehicles 101. The information processing apparatus 200 identifies a plurality of positions at which a plurality of captured images in which the similar vehicle, which is the target vehicle determined to be similar to the registered vehicle, is captured are captured by repeating the same determination on the feature information acquired from the other image capturing vehicles 101. The information processing apparatus 200 estimates at least one or more routes along which the similar vehicle has traveled on the basis of the plurality of identified positions ((3) in FIG. 1).

The information processing apparatus 200 accepts, from an information terminal (not shown) owned by a person using the information processing apparatus 200 to search for a stolen vehicle or by a user of a registered vehicle, request information for requesting information indicating a route along which the registered vehicle has traveled. When the request information is accepted, the information processing apparatus 200 transmits information indicating a route along which a similar vehicle, determined to be similar to the registered vehicle, has traveled to the information terminal. At this time, the information processing apparatus 200 outputs information indicating the route along which the similar vehicle has traveled, by a method described later, on the basis of confidence information indicating the degree of confidence representing the reliability of the features of the similar vehicle. In this way, when a vehicle is stolen, the information processing apparatus 200 can identify the route along which the stolen vehicle has traveled. At this time, the information processing apparatus 200 can suppress erroneous recognition of the stolen vehicle resulting from excessive trust in information indicating the features of a target vehicle with a low degree of confidence.

### [Configuration of the Image Capturing Vehicle]

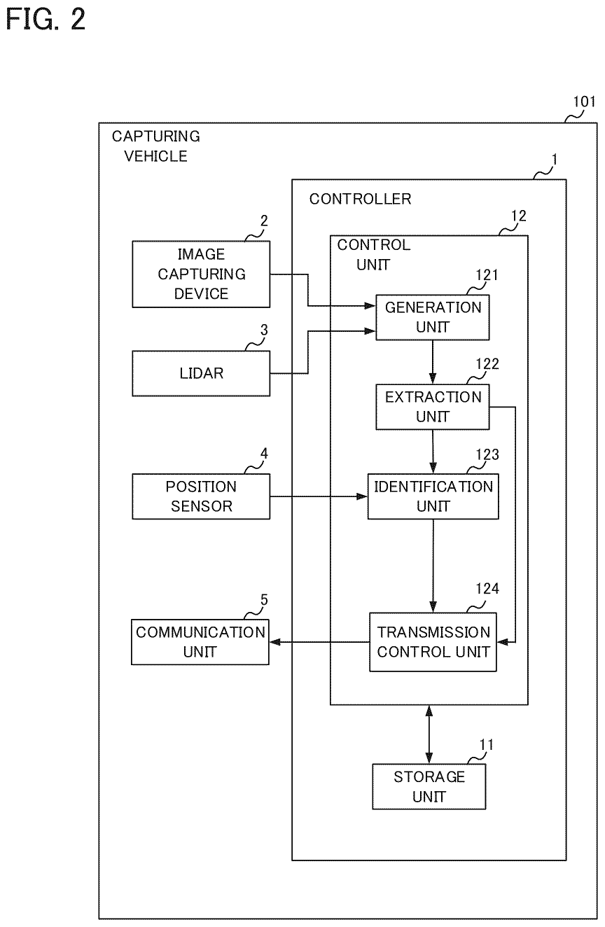

FIG. 2 is a diagram illustrating a configuration of the image capturing vehicle 101. The image capturing vehicle 101 includes a controller 1, an image capturing device 2, a LIDAR (Light Detection And Ranging) 3, a position sensor 4, and a communication unit 5.

The controller 1 is, for example, an ECU (Electronic Control Unit). The controller 1 includes a storage unit 11 and a control unit 12. The control unit 12 includes a generation unit 121, an extraction unit 122, an identification unit 123, and a transmission control unit 124.

The image capturing device 2 generates a captured image obtained by capturing the surroundings of the image capturing vehicle 101 while the image capturing vehicle 101 is traveling at a predetermined frame rate. The image capturing device 2 inputs the generated captured image to the generation unit 121. The LIDAR 3 measures the distance to objects around the image capturing vehicle 101 and the shapes of the objects by radiating a laser beam and measuring reflected waves of the laser beam. The LIDAR 3 inputs information indicating the measured distances to the objects and their shapes to the generation unit 121.

The position sensor 4 measures the position of the image capturing vehicle 101. The position sensor 4 has, for example, a GPS (Global Positioning System) receiver. The position sensor 4 identifies the latitude and longitude of the position of the image capturing vehicle 101 on the basis of position information included in radio waves received from GPS satellites. The position sensor 4 inputs the position information indicating the position of the image capturing vehicle 101 to the identification unit 123.

The communication unit 5 is a wireless communication module for communicating with the information processing apparatus 200. The communication unit 5 transmits various types of information input from the transmission control unit 124 to the information processing apparatus 200.

The storage unit 11 includes a ROM (Read Only Memory), a RAM (Random Access Memory, and the like, for example. The storage unit 11 stores programs to be executed by the control unit 12. The control unit 12 is, for example, a processor mounted on the ECU. The control unit 12 functions as the generation unit 121, the extraction unit 122, the identification unit 123, and the transmission control unit 124 by executing the programs stored in the storage unit 11.

The generation unit 121 generates shape information indicating the shapes of the objects around the image capturing vehicle 101 on the basis of at least one of (i) the captured images input from the image capturing device 2 or (ii) the measurement result of the LIDAR. The generation unit 121 may generate the shape information by a millimeter wave radar.

The extraction unit 122 extracts features of the target vehicle included in the captured image generated by the image capturing device 2. For example, the features of the target vehicle are at least one of a vehicle type, a color, or a vehicle registration number. For example, the extraction unit 122 determines a degree of confidence representing the reliability of the extracted features on the basis of the shape information generated by the generation unit 121. The extraction unit 122 may also determine the degree of confidence on the basis of the captured images. For example, when the shape indicated by the shape information is a shape of the target vehicle as viewed from a position where the front of the target vehicle is visible, the extraction unit 122 increases the degree of confidence of the extracted vehicle registration number, compared to a case where the shape is one as viewed from a position where the front of the target vehicle is not visible. When the shape indicated by the shape information is a shape of the target vehicle as viewed obliquely, the extraction unit 122 increases the degree of confidence of the extracted vehicle type, compared to a case where the shape is one as viewed from the front.

The extraction unit 122 may determine the degree of confidence using a machine learning model. In this case, the extraction unit 122 reads, from the storage unit 11, a learned machine learning model in which the shape information is input data and the vehicle type and a degree of confidence representing the reliability of the vehicle type are output data. The extraction unit 122 extracts the vehicle type and the degree of confidence of the target vehicle by inputting the shape information to the read machine learning model and acquiring the vehicle type and the degree of confidence of the vehicle type output by the machine learning model. The extraction unit 122 outputs the extracted features and a degree of confidence representing the reliability of the extracted features to the identification unit 123 and the transmission control unit 124.

The identification unit 123 identifies the position of the image capturing vehicle 101 on the basis of the position information input from the position sensor 4. The identification unit 123 outputs information indicating the identified position of the image capturing vehicle 101 to the transmission control unit 124.

The transmission control unit 124 transmits various types of information to the information processing apparatus 200 via the communication unit 5. The transmission control unit 124 transmits the feature information indicating the features of the target vehicle that appears in the captured image generated by the generation unit 121. The transmission control unit 124 transmits confidence information indicating the degree of confidence in the feature information. The transmission control unit 124 transmits position information indicating the position at which the captured image was captured to the information processing apparatus 200. The transmission control unit 124 transmits time information indicating the time at which the captured image was captured to the information processing apparatus 200.

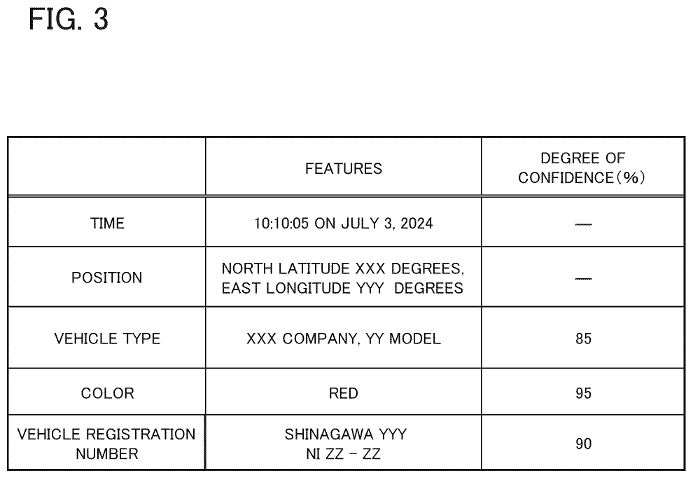

FIG. 3 illustrates an example of the feature information that the transmission control unit 124 transmits to the information processing apparatus 200. As shown in the first and second rows from the top of FIG. 3, the transmission control unit 124 transmits time information indicating the time “10:10:05 on Jul. 3, 2024” at which the captured image was captured, and position information indicating the position “north latitude XXX degrees, east longitude YYY degrees” at which the captured image was captured. As shown in the third row from the top of FIG. 3, the transmission control unit 124 transmits feature information indicating the vehicle type “XXX Company, YY model” of the target vehicle that appears in the captured image and confidence information indicating a degree of confidence of “85” %, representing the reliability of the vehicle type.

As illustrated in the fourth row from the top of FIG. 3, the transmission control unit 124 transmits feature information indicating the color “red” of the target vehicle that appears in the captured image and confidence information indicating a degree of confidence of “95” % in the color. As shown in the fifth row from the top of FIG. 3, the transmission control unit 124 transmits feature information indicating the vehicle registration number of the target vehicle that appears in the captured image, i.e., “Shinagawa YYY, Ni ZZ-ZZ” and confidence information indicating a degree of confidence of “90” % in the vehicle registration number.

### [Configuration of the Information Processing Apparatus 200]

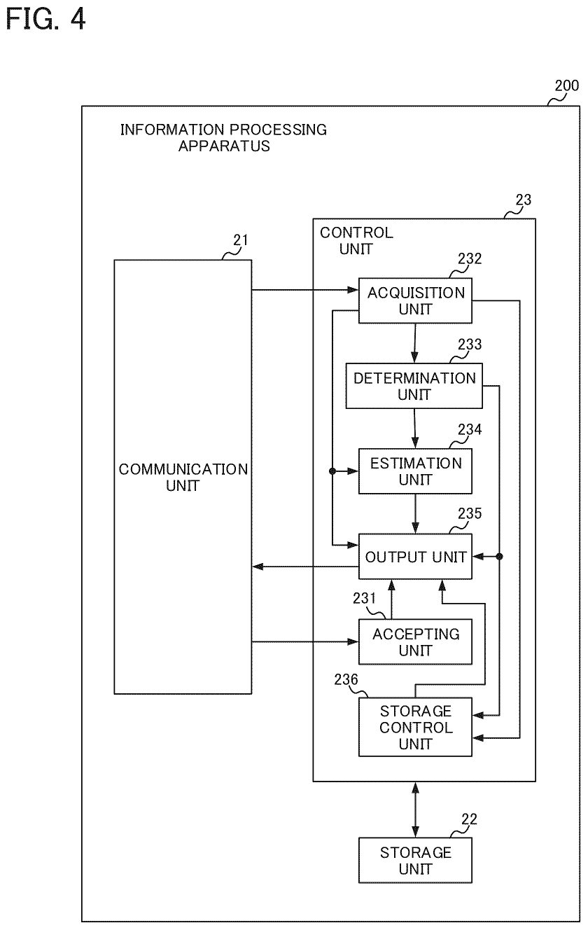

FIG. 4 shows a configuration of the information processing apparatus 200. The information processing apparatus 200 includes a communication unit 21, a storage unit 22, and a control unit 23. The control unit 23 includes an accepting unit 231, an acquisition unit 232, a determination unit 233, an estimation unit 234, an output unit 235, and a storage control unit 236.

The communication unit 21 is an interface for communicating with information terminals owned by users of the plurality of image capturing vehicles 101 and the registered vehicles. The communication unit 21 inputs the received various types of information to the control unit 23.

The storage unit 22 includes, for example, a ROM, a RAM, and the like. The storage unit 22 stores programs to be executed by the control unit 23. The features of the registered vehicle are stored in the storage unit 22. The features of the registered vehicle are at least one of a vehicle type, a color, or a vehicle registration number. In the example of FIG. 4, the features of the registered vehicle are stored in the storage unit 22 in association with identification information of the registered vehicle.

The control unit 23 is, for example, a CPU (Central Processing Unit). The control unit 23 functions as the accepting unit 231, the acquisition unit 232, the determination unit 233, the estimation unit 234, the output unit 235, and the storage control unit 236 by executing the programs stored in the storage unit 22.

The accepting unit 231 communicates, via the communication unit 21, with the information terminal owned by the user of the registered vehicle. The accepting unit 231 accepts, from the user's information terminal, first request information for requesting information on the position of the registered vehicle. The first request information includes the identification information (for example, a vehicle registration number) of the registered vehicle. The accepting unit 231 may accept, from the information terminal of the user of the registered vehicle, second request information for requesting information about the route along which the registered vehicle has traveled. The second request information includes the identification information of the registered vehicle. The second request information may include user-provided information indicating a parking location of the registered vehicle and a time at which the user last confirmed the registered vehicle. The accepting unit 231 outputs at least one of the accepted first request information or second request information to the output unit 235.

The acquisition unit 232 acquires, via the communication unit 21, various types of information from the plurality of image capturing vehicles 101. The acquisition unit 232 acquires, from the plurality of image capturing vehicles 101, (i) feature information indicating the features of a target vehicle included in the captured images obtained by capturing the surroundings of each of the plurality of image capturing vehicles 101, (ii) confidence information indicating a degree of confidence in the feature information, and (iii) position information indicating positions at which the captured images were captured. The acquisition unit 232 acquires time information indicating times at which the captured images were captured.

The acquisition unit 232 outputs the acquired feature information to the determination unit 233. The acquisition unit 232 outputs the acquired position information and the acquired time information to the estimation unit 234. The acquisition unit 232 outputs the acquired confidence information to the estimation unit 234 and the output unit 235.

The determination unit 233 determines whether the target vehicle is a similar vehicle on the basis of the features of the registered vehicle stored in the storage unit 22 and the features of the target vehicle indicated by the feature information acquired by the acquisition unit 232. The similar vehicle refers to a target vehicle having a similarity equal to or greater than a predetermined threshold value with any of the registered vehicles stored in the storage unit 22. The predetermined threshold value is, for example, a degree of similarity for which the probability that the registered vehicle and the similar vehicle do not match is 1%. The determination unit 233 may determine whether the target vehicle and the registered vehicle are similar or not by another method. For example, the determination unit 233 may determine similarity or dissimilarity using a learning model that determines the similarity or dissimilarity to the registered vehicle using a partial image of the target vehicle included in the captured image as input data. Alternatively, the determination unit 233 may determine the similarity or dissimilarity between the target vehicle and the registered vehicle included in the captured image using a method such as so-called image matching.

First, the determination unit 233 determines whether (i) the degree of confidence representing the reliability of the vehicle type of the target vehicle acquired by the acquisition unit 232 is equal to or greater than a first confidence threshold value α, and (ii) the degree of confidence representing the reliability of the color of the target vehicle is equal to or greater than a second confidence threshold value β. The first confidence threshold value α and the second confidence threshold value β are, for example, the minimum values of the degrees of confidence assumed when the captured images are generated in the standard environment. If the degree of confidence representing the reliability of the vehicle type of the target vehicle acquired by the acquisition unit 232 is equal to or greater than the first confidence threshold value α and the degree of confidence representing the reliability of the color of the target vehicle is equal to or greater than the second confidence threshold value β, the determination unit 233 identifies a first degree of similarity between the vehicle type of the registered vehicle and the vehicle type indicated by the feature information acquired by the acquisition unit 232. The determination unit 233 identifies a second degree of similarity between the color of the registered vehicle and the color indicated by the feature information acquired by the acquisition unit 232. The determination unit 233 identifies a third degree of similarity between the vehicle registration number of the registered vehicle and the vehicle registration number indicated by the feature information acquired by the acquisition unit 232.

The determination unit 233 determines whether the identified first degree of similarity is equal to or greater than a first threshold value and the identified second degree of similarity is equal to or greater than a second threshold value. The first threshold value is, for example, the minimum value of the first degree of similarity assumed between the registered vehicle and the target vehicle that have the same color when the captured images are generated in the standard environment. The second threshold value is, for example, the minimum value of the second degree of similarity assumed between the registered vehicle and the target vehicle that are of the same vehicle type when the captured images are generated in the standard environment.

If the first degree of similarity is equal to or greater than the first threshold value and the second degree of similarity is equal to or greater than the second threshold value, the determination unit 233 determines whether a degree of confidence representing the reliability of the vehicle registration number of the target vehicle acquired by the acquisition unit 232 is equal to or greater than a third confidence threshold value γ. The third confidence threshold value γ is, for example, the minimum value of the degree of confidence assumed when captured images are generated in the standard environment.

If the degree of confidence representing the reliability of the vehicle registration number of the target vehicle is equal to or greater than the third confidence threshold value γ, the determination unit 233 identifies a third degree of similarity between the vehicle registration number of the registered vehicle and the vehicle registration number indicated by the feature information acquired by the acquisition unit 232. The determination unit 233 determines whether the identified third degree of similarity is equal to or greater than a third threshold value. The third threshold value is, for example, the minimum value of the third degree of similarity assumed between the registered vehicle and the target vehicle that have the same vehicle registration number when the captured images are generated in the standard environment. If it is determined that the third degree of similarity is equal to or greater than the third threshold value, the determination unit 233 associates (i) the position information and the time information corresponding to the feature information acquired by the acquisition unit 232 and (ii) the registered vehicle with each other, labels them as main information, and stores the main information in the storage unit 22.

On the other hand, if the first degree of similarity is equal to or greater than the first threshold value and the second degree of similarity is equal to or greater than the second threshold value, but the degree of confidence representing the reliability of the vehicle registration number of the registered vehicle is less than the third confidence threshold value γ, the determination unit 233 associates (i) the position information and the time information corresponding to the feature information acquired by the acquisition unit 232 and (ii) the identification information of the registered vehicle with each other, labels them as reference information, and store the reference information in the storage unit 22.

If the degree of confidence representing the reliability of the vehicle type of the target vehicle acquired by the acquisition unit 232 is less than the first confidence threshold value α or if the degree of confidence representing the reliability of the color of the target vehicle is less than the second confidence threshold value β, the determination unit 233 discards the position information and the time information corresponding to the feature information acquired by the acquisition unit 232 without storing them in the storage unit 22. If the identified first degree of similarity is less than the first threshold value, if the second degree of similarity is less than the second threshold value, or if the third degree of similarity is less than the third threshold value, the determination unit 233 discards the position information and the time information corresponding to the feature information acquired by the acquisition unit 232 without storing them in the storage unit 22. The determination unit 233 repeats the same determination process between the features of each of the registered vehicles stored in the storage unit 22 and the features of the target vehicle indicated by the feature information acquired by the acquisition unit 232.

The determination unit 233 may calculate a comprehensive degree of similarity on the basis of the first degree of similarity, the second degree of similarity, and the third degree of similarity. For example, the determination unit 233 may calculate a comprehensive degree of similarity by performing a weighted average on the first degree of similarity, the second degree of similarity, and the third degree of similarity.

The determination unit 233 determines whether the calculated comprehensive degree of similarity is equal to or greater than a predetermined comprehensive threshold value. If it is determined that the calculated comprehensive degree of similarity is equal to or greater than a comprehensive threshold value, the determination unit 233 may associate (i) the position information and the time information corresponding to the feature information acquired by the acquisition unit 232 and (ii) the identification information of the registered vehicle with each other, may label them as main information, and may store the main information in the storage unit 22. The comprehensive threshold value is, for example, a degree of similarity for which the probability that the registered vehicle and the similar vehicle do not match is 1%.

On the other hand, if it is determined that the calculated comprehensive degree of similarity is less than the comprehensive threshold value, the determination unit 233 may discard both the position information and the time information corresponding to the determined degree of similarity without storing them in the storage unit 22.

### [Route Estimation]

The estimation unit 234 estimates a route along which the similar vehicle has traveled. For example, the estimation unit 234 estimates at least one or more routes along which the similar vehicle has traveled, on the basis of a plurality of positions at which a plurality of captured images, in which the similar vehicle that is determined to be similar to the registered vehicle by the determination unit 233 is captured, were captured. The estimation unit 234 estimates a trajectory along which the similar vehicle has traveled on one or more routes, on the basis of the relationship between the plurality of positions and a plurality of times at which the plurality of captured images were captured. The trajectory is represented by the route along which the similar vehicle has traveled and the times at which the similar vehicle arrived at each of a plurality of positions on that route.

More specifically, the estimation unit 234 reads, from the storage unit 22, the position information and the time information that are labeled and stored as the main information in the storage unit 22 in association with the identification information of the registered vehicle. The estimation unit 234 estimates the trajectory along which the similar vehicle has traveled by plotting the positions indicated by the read position information on map data in the order of the times indicated by the time information corresponding to the positions.

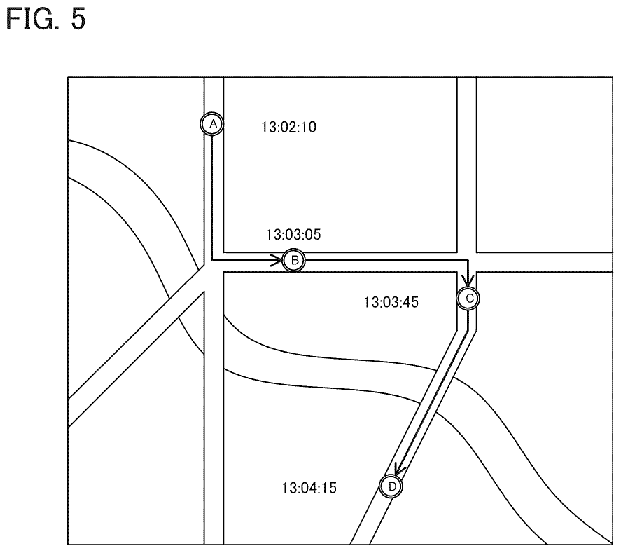

FIG. 5 illustrates an example of a travel trajectory of the similar vehicle estimated by the estimation unit 234. Double circles in FIG. 5 indicate positions indicated by the plurality of pieces of position information acquired by the acquisition unit 232 from the plurality of image capturing vehicles 101. The estimation unit 234 estimates a trajectory such that the positions indicated by these pieces of position information are passed through in the order of times indicated by the time information corresponding to the position information. In the example of FIG. 5, the estimation unit 234 estimates a trajectory passing through, in order, a position A corresponding to the time “13:02:10”, a position B corresponding to the time “13:03:05”, a position C corresponding to the time “13:03:45”, and a position D corresponding to the time “13:04:15”.

In order to prevent a target vehicle different from the registered vehicle from being erroneously recognized as the similar vehicle, the estimation unit 234 estimates a route along which the similar vehicle has traveled (hereinafter, also referred to as a first confidence route) on the basis of positions of a plurality of similar vehicles acquired by the acquisition unit 232 in association with the plurality of pieces of confidence information indicating the degree of confidence equal to or greater than a predetermined threshold value. For example, the estimation unit 234 estimates the first route along which the similar vehicle has traveled, on the basis of the positions of the plurality of similar vehicles acquired by the acquisition unit 232 in association with the color corresponding to a degree of confidence of the first confidence threshold value α or more, the vehicle type corresponding to a degree of confidence of the second confidence threshold value β or more, and the vehicle registration number corresponding to a degree of confidence of the third confidence threshold value γ or more. The estimation unit 234 may estimate a plurality of first confidence routes by repeating the same process. In this way, since the estimation unit 234 estimates the route of the similar vehicle by using the feature information with relatively high reliability, it is possible to reduce the risk of erroneously recognizing a target vehicle different from the registered vehicle as the similar vehicle.

In contrast, there are cases where the estimation unit 234 cannot estimate the first confidence route. In such cases, the estimation unit estimates a route along which the similar vehicle has traveled (hereinafter, also referred to as a second confidence route) on the basis of positions of a plurality of similar vehicles, including the position of the similar vehicle acquired by the acquisition unit 232 in association with the confidence information indicating a degree of confidence less than the threshold value.

For example, when it is determined that the position information or the like labeled as the main information is not stored in association with the identification information of the registered vehicle included in the second request information accepted by the accepting unit 231, the estimation unit 234 identifies the parking location of the registered vehicle and the time at which the user last confirmed the registered vehicle indicated by the user-provided information accepted by the accepting unit 231. The estimation unit 234 identifies position information labeled as the reference information, which is position information indicating a position that the registered vehicle is estimated to be unable to reach from the parking location of the registered vehicle. The estimation unit 234 deletes the identified position information and the time information corresponding to the identified position information from the storage unit 22. The estimation unit 234 estimates the second confidence route along which the similar vehicle has traveled by plotting positions indicated by the rest of the position information labeled as the reference information stored in the storage unit 22.

When the number of positions of the plurality of similar vehicles labeled as the main information is smaller than the number of via points necessary to estimate the route of the similar vehicle, the estimation unit 234 may estimate the second confidence route. The estimation unit 234 may also estimate the second confidence route when the distance between the positions of the plurality of similar vehicles labeled as the main information is equal to or greater than a reference value. The reference value is, for example, several kilometers or several tens of kilometers.

The estimation unit 234 may transition from a state in which it is unable to estimate the first confidence route to a state in which it becomes able to estimate the first confidence route. When the estimation unit 234 transitions from the state in which it is unable to estimate the first confidence route to the state in which it becomes able to estimate the first confidence route, the estimation unit 234 newly estimates the first confidence route.

Even when the features of a target vehicle corresponding to a degree of confidence equal to or greater than a threshold value are compared with the features of a similar vehicle, the determination unit 233 may erroneously determine a target vehicle that is different from the registered vehicle as the similar vehicle. In such a case, a plurality of similar vehicles may appear to be present at different positions at the same time. Therefore, when the distance between a plurality of positions at which the similar vehicles are identified exceeds the maximum possible travel distance between the plurality of times at which the captured images corresponding to those plurality of positions were captured, the estimation unit 234 estimates that the plurality of similar vehicles identified at those plurality of positions are different vehicles. In this case, the estimation unit 234 estimates a route along which one of the similar vehicles travels without passing through the position at which the other similar vehicle was captured.

Specifically, the estimation unit 234 estimates (i) a travel distance over which the similar vehicle travels from the position at which the first captured image including the similar vehicle was captured to the position at which the second captured image including the similar vehicle was captured, the second captured image being captured after the time at which the first captured image was captured, and (ii) a time difference between the time at which the first captured image was captured and the time at which the second captured image was captured. The estimation unit 234 estimates a travel speed of the similar vehicle on the basis of the estimated travel distance and the estimated time difference. When the estimated travel speed of the similar vehicle exceeds a predetermined value, the estimation unit 234 does not include the position at which the second captured image was captured in the route along which the registered vehicle has traveled. The predetermined value is, for example, the maximum speed at which the similar vehicle is capable of traveling or a speed that is three times the speed limit.

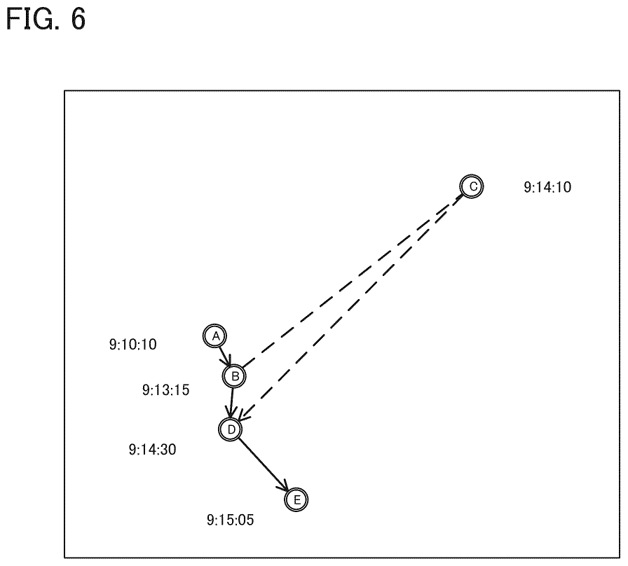

FIG. 6 shows an example of a method of increasing route estimation accuracy in the manner described above. First, in the example of FIG. 6, the estimation unit 234 estimates a trajectory of the vehicle 100 passing through positions A, B, C, D, and E on the assumption that the similar vehicle passes through the positions A, B, C, D, and E which are indicated by the position information acquired by the acquisition unit 232, in the order of times indicated by the time information corresponding to the position information. In this case, the estimation unit 234 estimates the trajectory that passes through, in order, the position A corresponding to the time “9:10:10”, the position B corresponding to the time “9:13:15”, the position C corresponding to the time “9:14:10”, the position D corresponding to the time “9:14:30”, and the position E corresponding to the time “9:15:05”.

The estimation unit 234 estimates the travel speed of the similar vehicle from the position A to the position B, the travel speed from the position B to the position C, the travel speed from the position C to the position D, and the travel speed from the position D to the position E along the estimated trajectory. In the example of FIG. 6, the travel speed of the similar vehicle from the position B to the position C estimated by the estimation unit 234 exceeds the predetermined value. Similarly, the travel speed from the position C to the position D estimated by the estimation unit 234 also exceeds the predetermined value. On the other hand, the travel speed of the similar vehicle from the position A to the position B estimated by the estimation unit 234 and the travel speed of the similar vehicle from the position D to the position E are both equal to or less than the predetermined value. In this case, the estimation unit 234 newly estimates a trajectory along which the similar vehicle travels without passing through the position C. As indicated by solid arrows in FIG. 6, the estimation unit 234 estimates the new trajectory passing through the position B, the position D, and the position E in order from the position A.

### [Outputting Various Types of Information]

The output unit 235 communicates, via the communication unit, with the information terminal owned by a person using the information processing apparatus 200 to search for the stolen vehicle or by the user of the registered vehicle. When the accepting unit 231 accepts the first request information for requesting the information on the position of the registered vehicle, the output unit 235 identifies the position information stored in the storage unit 22 in association with the identification information of the registered vehicle. The output unit 235 transmits the identified position information to the information terminal.

When the accepting unit 231 accepts the second request information for requesting the information on the route along which the registered vehicle has traveled, the output unit 235 outputs at least one or more routes estimated by the estimation unit 234 for the similar vehicle that the determination unit 233 has determined to have the degree of similarity to the registered vehicle equal to or greater than the predetermined threshold value. When the estimation unit 234 estimates a trajectory along which the similar vehicle has traveled on one or more routes, the output unit 235 outputs that trajectory estimated by the estimation unit 234 as the route.

The output unit 235 outputs the route along which the similar vehicle has traveled on the basis of (i) the plurality of positions at which the plurality of captured images including the similar vehicle were captured and (ii) the degree of confidence of the features of the similar vehicle. The output unit 235 outputs at least one or more routes estimated by the estimation unit 234. For example, the output unit 235 outputs the route in different formats depending on the degree of confidence. Specifically, the output unit 235 outputs, in red, a route that passes through only positions where the captured images in which the degree of confidence of the vehicle registration number of the similar vehicle is equal to or greater than the threshold value were captured. The output unit 235 outputs, in blue, a route including positions where the captured images in which the degree of confidence of the vehicle registration number of the similar vehicle is less than the threshold value were captured. By having the output unit 235 output the route in the different formats depending on the degree of confidence as described above, a person viewing the output route can more easily determine whether the vehicle should be searched for at the current position of the similar vehicle as output.

Among the at least one or more routes estimated by the estimation unit 234, the output unit 235 may prioritize outputting a route (hereinafter, also referred to as a main route) that passes through positions where one or more captured images whose degree of confidence is equal to or greater than the predetermined threshold value were captured, over a route (hereinafter, also referred to as a sub-route) that passes through positions where one or more captured images whose degree of confidence is less than the threshold value were captured. For example, the output unit 235 displays the main route on a first page of a map for displaying the route along which the registered vehicle has traveled, which is displayed on the information terminal of the user of the registered vehicle. The output unit 235 displays the sub-route on a second page of the map.

Additionally, the output unit 235 may output at least one or more routes estimated by the estimation unit 234 together with the confidence information corresponding to each route. For example, the output unit 235 may display the degree of confidence of the vehicle registration number extracted from the captured images at each of the positions where the captured images including the similar vehicle were captured along the route estimated by the estimation unit 234.

When the estimation unit 234 has estimated the first confidence route, the output unit 235 outputs the estimated first confidence route. When the estimation unit 234 has estimated the second confidence route in the state in which the estimation unit 234 is unable to estimate the first confidence route, the output unit 235 outputs the estimated second confidence route. When the estimation unit 234 transitions from the state in which it is unable to estimate the first confidence route to the state in which it becomes able to estimate the first confidence route, the output unit 235 stops outputting the second confidence route estimated by the estimation unit 234. In this case, the output unit 235 outputs a first confidence route newly estimated by the estimation unit 234.

[Deletion of Information on Target Vehicles Other than the Registered Vehicle]

The storage control unit 236 causes the storage unit 22 to store the position information acquired by the acquisition unit 232. When the determination unit 233 determines that the degree of similarity between the features of the registered vehicle stored in the storage unit 22 and the features of the target vehicle indicated by the feature information acquired by the acquisition unit 232 is equal to or greater than a predetermined threshold value, the storage control unit 236 causes the storage unit 22 to store, for a predetermined period, position information indicating a position at which the captured image including the target vehicle was captured, in association with the registered vehicle. For example, when the determination unit 233 determines that the comprehensive degree of similarity between the features of the registered vehicle stored in the storage unit 22 and the features of the target vehicle indicated by the feature information acquired by the acquisition unit 232 is equal to or greater than the comprehensive threshold value, the storage control unit 236 causes the storage unit 22 to store, for a predetermined period, position information indicating the position at which the captured image including the target vehicle was captured, in association with the registered vehicle. The predetermined period is, for example, a period designated by the user of the registered vehicle.

When the determination unit 233 determines that the degree of similarity between the features of the registered vehicle stored in the storage unit 22 and the features of the target vehicle indicated by the feature information acquired by the acquisition unit 232 is less than the predetermined threshold value, the storage control unit 236 deletes the position information from the storage unit 22 without causing the storage unit 22 to store, for the predetermined period, the position information indicating the position at which the captured image including the target vehicle was captured in the storage unit 22. In this way, since the storage control unit 236 immediately deletes the captured image including the target vehicle that is unlikely to be the registered vehicle, it is possible to prevent the capacity of the storage unit 22 from becoming insufficient.

[Modification of Acquiring Feature Information and Confidence Information from Machine Learning Model]

In the present embodiment, the example of the case where the acquisition unit 232 acquires, from the image capturing vehicles 101, (i) the feature information indicating the features of the target vehicle that appears in the captured images obtained by capturing the surroundings of each of the plurality of image capturing vehicles 101 and (ii) the confidence information indicating the degree of confidence in the feature information was explained. The acquisition unit 232 may acquire feature information and confidence information output by a learned machine learning model stored in the storage unit 22. First, the acquisition unit 232 acquires the shape information generated by the generation unit 121 from the image capturing vehicle 101. The acquisition unit 232 may input the shape information to the learned machine learning model in which the shape information is input data and the vehicle type and the degree of confidence representing the reliability of the vehicle type are output data, and acquire the vehicle type and the degree of confidence of the vehicle type output by the machine learning model.

### [Processing Procedure of Managing Position Information Corresponding to Feature Information]

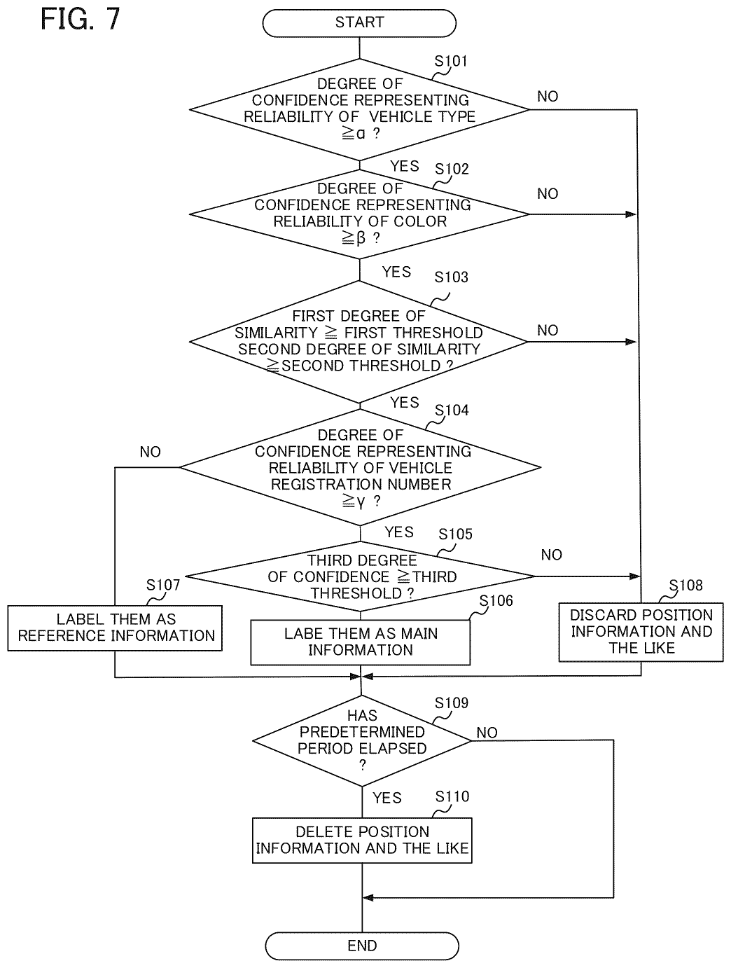

FIG. 7 is a flowchart showing a processing procedure of managing position information corresponding to feature information acquired by the acquisition unit 232. This processing procedure starts, for example, when the accepting unit 231 accepts an operation of a user who registers the features of a registered vehicle.

First, the determination unit 233 determines whether a degree of confidence representing the reliability of a vehicle type of a target vehicle acquired by the acquisition unit 232 is equal to or greater than a first confidence threshold value α (S101). If the degree of confidence representing the reliability of the vehicle type of the target vehicle acquired by the acquisition unit 232 is equal to or greater than the first confidence threshold value α (YES in S101), the determination unit 233 determines whether a degree of confidence representing the reliability of a color of the target vehicle is equal to or greater than a second confidence threshold value β (S102). If the degree of confidence representing the reliability of the color of the target vehicle acquired by the acquisition unit 232 is equal to or greater than the second confidence threshold value β (YES in S102), the determination unit 233 determines a first degree of similarity between the vehicle type of the registered vehicle and the vehicle type indicated by the feature information acquired by the acquisition unit 232. The determination unit 233 identifies a second degree of similarity between the color of the registered vehicle and the color indicated by the feature information acquired by the acquisition unit 232. The determination unit 233 determines whether (i) the first degree of similarity is equal to or greater than a first threshold value and (ii) the second degree of similarity is equal to or greater than a second threshold value (S103).

If the first degree of similarity is equal to or greater than the first threshold value and the second degree of similarity is equal to or greater than the second threshold value (YES in S103), the determination unit 233 determines whether a degree of confidence representing the reliability of the vehicle registration number of the target vehicle acquired by the acquisition unit 232 is equal to or greater than a third confidence threshold value γ (S104).

If the degree of confidence representing the reliability of the vehicle registration number of the target vehicle is equal to or greater than the third confidence threshold value γ (YES in S104), the determination unit 233 identifies a third degree of similarity between the vehicle registration number of the registered vehicle and the vehicle registration number indicated by the feature information acquired by the acquisition unit 232. The determination unit 233 determines whether the third degree of similarity is equal to or greater than a third threshold value (S105). If it is determined that the third degree of similarity is equal to or greater than the third threshold value (YES in S105), the determination unit 233 associates (i) the position information and the time information corresponding to the feature information acquired by the acquisition unit 232 and (ii) the registered vehicle with each other, labels them as main information, and stores the main information in the storage unit 22 (S106).

If the degree of confidence representing the reliability of the vehicle registration number of the registered vehicle is less than the third confidence threshold value γ (NO in S104), the determination unit 233 associates (i) the position information and the time information corresponding to the feature information acquired by the acquisition unit 232, and (ii) the identification information of the registered vehicle with each other, labels them as reference information, and stores the reference information in the storage unit 22 (S107). In a case where the degree of confidence of the vehicle type is less than the first confidence threshold value α (NO in S101) and in a case where the degree of confidence of the color is less than the second confidence threshold value β (NO in S102), the position information and the time information acquired by the acquisition unit 232 are discarded (S108). In this case, the positional information is not discarded even when the degree of confidence of the vehicle registration number indicated by the confidence information acquired by the acquisition unit 232 is less than the third confidence threshold value γ (NO in S104). This is because the degree of similarity between the features other than the vehicle registration number and those of the registered vehicle is high. As a result, the positional information can still be used as the reference information when the acquisition unit 232 is unable to acquire the position information and the like that are labeled as the main information.

If the degree of confidence representing the reliability of the vehicle type of the registered vehicle is less than the first confidence threshold value α in the determination in S101 (NO in S101), the determination unit 233 discards the position information and the time information corresponding to the feature information acquired by the acquisition unit 232 (S108). If the degree of confidence representing the reliability of the color of the registered vehicle is less than the second confidence threshold value β in the determination in S102 (NO in S102), the determination unit 233 proceeds to the process of S108. If the first degree of similarity is less than the first threshold value or the second degree of similarity is less than the second threshold value in the determination in S103 (NO in S103), the determination unit 233 proceeds to the process of S108. When the third degree of similarity is less than the third threshold value in the determination in S105 (NO in S105), the determination unit 233 proceeds to the process of S108.

The storage control unit 236 determines whether a predetermined period has elapsed after position information indicating a position at which the captured image including the similar vehicle was captured and the time information are associated with the identification information of the registered vehicle, labeled as the main information or the reference information, and stored in the storage unit 22 (S109). If it is determined that the predetermined period has elapsed since the position information and the time information were stored in the storage unit 22 in association with the identification information of the registered vehicle (YES in S109), the storage control unit 236 deletes the position information and the time information from the storage unit 22 (S110), and ends the process.

If it is determined in the determination in S109 that the predetermined period has not elapsed since the position information indicating the position at which the captured image including the similar vehicle and the time information were stored in the storage unit 22 in association with the identification information of the registered vehicle (NO in S109), the storage control unit 236 ends the process without deleting the position information from the storage unit 22.

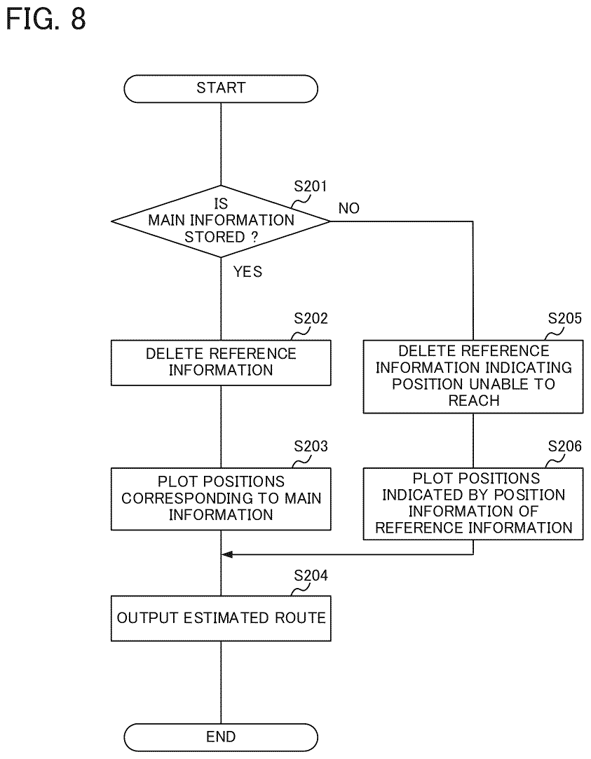

FIG. 8 is a flowchart showing a processing procedure of estimating the route of the registered vehicle by the information processing apparatus 200. This processing procedure starts, for example, when second request information for requesting the information on the route along which a registered vehicle has traveled is accepted from an information terminal of a user of the registered vehicle.

The estimation unit 234 determines whether the position information and the time information that are labeled as the main information are stored in the storage unit 22 in association with the identification information of the registered vehicle included in the second request information accepted by the accepting unit 231 (S201). If the position information and the time information that are labeled as the main information are stored in the storage unit 22 (YES in S201), the estimation unit 234 deletes the position information and the time information that are labeled as the reference information from the storage unit 22 (S202).

The estimation unit 234 estimates a route along which the similar vehicle has traveled by plotting the positions indicated by the position information labeled as the main information on a map (S203). The output unit 235 outputs the route estimated by the estimation unit 234 to the information terminal of the user of the registered vehicle (S204), and ends the process.

When it is determined in the determination in S201 that the position information or the like labeled as the main information is not stored in association with the identification information of the registered vehicle included in the second request information accepted by the accepting unit 231 (NO in S201), the estimation unit 234 identifies a parking location of the registered vehicle indicated by user-provided information accepted by the accepting unit 231 and a time at which the user last confirmed the registered vehicle. The estimation unit 234 identifies position information and the time information labeled as reference information, which are position information indicating a position at which the registered vehicle is estimated to be unable to reach from the parking location of the registered vehicle. The estimation unit 234 deletes the identified position information and the time information corresponding to the identified position information from the storage unit 22 (S205). The estimation unit 234 estimates the route along which the similar vehicle has traveled by plotting positions indicated by the rest of the position information labeled as the reference information stored in the storage unit 22 (S206), and proceeds to the process of S204.

### [Effects of the Information Processing Apparatus 200 According to the Present Disclosure]

In the information processing apparatus 200 according to the present embodiment, the output unit 235 selects a route to be output as the route along which the registered vehicle has traveled, or outputs the route along which the registered vehicle has traveled in a format corresponding to the degree of confidence of the features of the similar vehicle, on the basis of the degree of confidence of the features of the similar vehicle. In this way, when the vehicle is stolen, the output unit 235 can output the route along which the stolen vehicle has traveled. At this time, the output unit 235 can suppress erroneous recognition of the stolen vehicle resulting from excessive trust in information indicating the features of the vehicle with a low degree of confidence.

The present disclosure is explained based on the exemplary embodiments. The technical scope of the present disclosure is not limited to the scope explained in the above embodiments and it is possible to make various changes and modifications within the scope of the disclosure. For example, all or part of the device can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An information processing apparatus comprising:
an acquisition unit that acquires, from a plurality of image capturing vehicles, (i) feature information indicating features of a target vehicle included in captured images obtained by capturing surroundings of each of the plurality of image capturing vehicles, (ii) confidence information indicating a degree of confidence in the feature information, and (iii) position information indicating positions at which the captured images were captured;
a storage unit that stores features of a registered vehicle;
a determination unit that determines whether the target vehicle is a similar vehicle on the basis of the features of the registered vehicle and the features of the target vehicle indicated by the feature information; and
an output unit that outputs a route along which the similar vehicle has traveled on the basis of (i) a plurality of positions at which a plurality of captured images including the similar vehicle were captured and (ii) a degree of confidence of features of the similar vehicle.

2. The information processing apparatus according to claim 1, wherein the output unit outputs a trajectory along which the similar vehicle has traveled on the route on the basis of times at which the plurality of captured images were captured.

3. The information processing apparatus according to claim 1, wherein the output unit outputs the route excluding a position at which a second captured image including the similar vehicle was captured, when a distance from a position at which a first captured image including the similar vehicle was captured to a position at which the second captured image was captured exceeds a predetermined value, the second captured image having been captured after the first captured image.

4. The information processing apparatus according to claim 1, wherein the output unit prioritizes outputting the route that passes through positions where one or more captured images whose degree of confidence is equal to or greater than a predetermined threshold value were captured, over the route that passes through positions where one or more captured images whose degree of confidence is less than the threshold value were captured.

5. The information processing apparatus according to claim 1, wherein the output unit outputs a second confidence route along which the similar vehicle has traveled as the route, on the basis of positions of a plurality of the similar vehicles, including the position of the similar vehicle acquired by the acquisition unit in association with the confidence information indicating a degree of confidence less than a predetermined threshold value, when a first confidence route along which the similar vehicle has traveled cannot be output as the route on the basis of positions of a plurality of the similar vehicles acquired by the acquisition unit in association with a plurality of pieces of confidence information indicating the degree of confidence equal to or greater than the threshold value.

6. The information processing apparatus according to claim 5, wherein the output unit stops outputting the second confidence route when a state in which the first confidence route cannot be output is transitioned to a state in which the first confidence route can be output.

7. The information processing apparatus according to claim 1, further comprising:
a storage control unit that causes the storage unit to store, for a predetermined period, position information indicating a position at which the captured image including the target vehicle was captured in association with the registered vehicle, when the determination unit determines that a degree of similarity between the features of the registered vehicle stored in the storage unit and the features of the target vehicle indicated by the feature information is equal to or greater than a threshold value, and deletes the position information from the storage unit without causing the storage unit to store, for the predetermined period, the position information indicating the position at which the captured image including the target vehicle was captured, when the determination unit determines that the degree of similarity between the features of the registered vehicle stored in the storage unit and the features of the target vehicle indicated by the feature information is less than the threshold value; and
an accepting unit that accepts, from a user's terminal, request information for requesting information on the position of the registered vehicle, wherein
the output unit transmits, to the user's terminal, the position information stored in the storage unit in association with the registered vehicle when the accepting unit accepts the request information.

8. The information processing apparatus according to claim 1, wherein the output unit outputs at least one or more routes along which the similar vehicle has traveled in different formats depending on the degree of confidence corresponding to the route when the determination unit determines that the target vehicle is the similar vehicle.

9. The information processing apparatus according to claim 1, wherein the output unit 235 outputs each of at least one or more routes along which the similar vehicle has traveled, together with confidence information corresponding to the route.

10. An information processing method comprising the computer-implemented steps of:
acquiring, from a plurality of image capturing vehicles, (i) feature information indicating features of a target vehicle included in captured images obtained by capturing surroundings of each of the plurality of image capturing vehicles, (ii) confidence information indicating a degree of confidence in the feature information, and (iii) position information indicating positions at which the captured images were captured;
determining whether the target vehicle is a similar vehicle on the basis of the features of a registered vehicle and the features of the target vehicle indicated by the feature information by referencing a storage unit that stores the features of the registered vehicle; and
outputting a route along which the similar vehicle has traveled on the basis of (i) a plurality of positions at which a plurality of captured images including the similar vehicle were captured and (ii) a degree of confidence of features of the similar vehicle.

11. An information processing system comprising a plurality of image capturing vehicles that capture surroundings; and an information processing apparatus that communicates with the plurality of image capturing vehicles, wherein any one of the image capturing vehicles includes:
an image capturing device that generates captured images of the surroundings of the image capturing vehicle;
an extraction unit that extracts features of a target vehicle included in the captured images; and
a transmission control unit that transmits, to the information processing apparatus, (i) feature information indicating features of the target vehicle included in the captured images, (ii) confidence information indicating a degree of confidence in the feature information, and (iii) position information indicating positions at which the captured images were captured, and
the information processing apparatus includes:
an acquisition unit that acquires, from the plurality of image capturing vehicles, (i) feature information indicating features of a target vehicle included in captured images obtained by capturing surroundings of each image capturing vehicle, (ii) confidence information indicating a degree of confidence in the feature information, and (iii) position information indicating positions at which the captured images were captured;
a storage unit that stores features of a registered vehicle;
a determination unit that determines whether the target vehicle is a similar vehicle on the basis of the features of the registered vehicle and the features of the target vehicle indicated by the feature information; and
an output unit that outputs a route along which the similar vehicle has traveled on the basis of (i) a plurality of positions at which a plurality of captured images including the similar vehicle were captured and (ii) a degree of confidence of features of the similar vehicle.
